(19) United States
(12) Patent Application Publication
(10) Pub. No.: US 2017/0004577 A1
(43) Pub. Date: Jan. 5, 2017

(54) APPARATUS, SYSTEM AND METHOD FOR ENABLING ACCOUNT OPENING

(71) Applicant: Complii Pty Ltd, Perth (AU)

(72) Inventor: Anthony Cunningham, City Beach (AU)

(21) Appl. No.: 15/167,620

(22) Filed: May 27, 2016

(30) Foreign Application Priority Data
May 27, 2015 (AU) 2015901953

(51) Int. Cl. G06Q 40/04; G06Q 20/38; G06Q 20/32; G06Q 20/40

(52) U.S. Cl. CPC G06Q 40/04; G06Q 20/4016; G06Q 20/40145; G06Q 20/3825; G06Q 20/3226

(57) ABSTRACT

The invention relates to an apparatus, system and method for enabling opening of accounts, utilising a mobile device. An administrator is able to use their mobile device to obtain customer information necessary to open an account for the customer. The customer information is processed in the mobile device and also communicated with remote devices for authorisation and verification. Once verification has been achieved, an account may be opened.

### CROSS-REFERENCE TO RELATED APPLICATIONS

This application claims the benefit of Australian Patent Application No. 2015901953, filed May 27, 2015, which is hereby incorporated by reference for all purposes.

### FIELD OF THE INVENTION

The present invention relates to an apparatus, system and method for enabling opening of accounts, and, particularly, but not exclusively, to an apparatus, system and method that enables opening of accounts via a mobile device.

### BACKGROUND OF THE INVENTION

The opening of an account with any organisation will usually require identification details and verification of the person or organisation opening the account. This will usually require the person to physically attend at a location of the organisation or institution and present recognised identification data, such as drivers license, passport or other identification information. Further to this the individual or the organisation would require either a printer and paper account forms or a desktop computer to enter the account details.

Additionally, various security checks may need to be carried out, depending on the type of account being opened. For example, to open a trading account to trade in stocks, shares or other equity in businesses, sophisticated security checks, such as anti-money laundering (AML) authentication are required. This may require the organisation administering the account to make detailed enquiries with other systems/organisations in order to carry out the security checks.

The identity and security requirements make the account opening process a laborious one.

### SUMMARY OF THE INVENTION

In accordance with a first aspect, the present invention provides an apparatus for enabling account opening, comprising a computing device having a processor, memory and an operating system supporting computer processes, a data interface process arranged to capture customer data of a customer wishing to open an account, an authorisation process arranged to authorise, based on the customer data, opening of a customer account.

In an embodiment, the apparatus is a mobile apparatus. It may be a smartphone, tablet, or any other mobile computing device. The use of a mobile device to enable account opening has the advantage, in at least an embodiment, that action can be taken to open an account anywhere. The person wishing to open the account does not have to attend at a particular location. An account can, in an embodiment, be opened in “real time” at a location chosen by the person wishing to open the account, or any other location. This is without the need for paper forms a printer or a desktop computer.

In an embodiment, the apparatus further comprises a communications interface for communicating with remote system(s). In an embodiment, the authorisation process is arranged to communicate the customer data to a remote system where verification steps are carried out utilising the data. In an embodiment, the authorisation process is arranged to receive, from the remote system, authorisation for account opening.

In an embodiment, the data interface process is arranged to capture administrator data of an administrator administering opening of the account. In an embodiment, the administrator data may be identification data of the administrator. It may be a signature of the administrator or any biometric data of the administrator, or any other identification data.

In an embodiment, where the data interface process is arranged to capture administrator data, the authorisation process is arranged to require the administrator data in order to authorise account opening. In an embodiment, the authorisation process is arranged to send the administrator data to a remote system where verification steps are carried out on the administrator data.

Having an administrator sign off on the account opening process, in an embodiment, provides the advantage of a further check on the identity and bonafides of the customer.

In an embodiment, a computing device associated with the administrator comprises the apparatus. It may be a mobile device, for example.

In an embodiment, the customer data comprises identity data of the customer. It may comprise signature data, image data (e.g. copy of a photograph), or any other biometric, or any other identification data. Customer data may comprise name details, address details, date of birth details, or any other details.

In an embodiment, the data interface process is arranged to capture an image which may contain customer data. It may capture an image of an identification card, driving license, business card or any other image. The apparatus may comprise a camera to facilitate this. In an embodiment, text in the image may be converted to digital text and visual information such as facial images may be converted to digital images and processed to verify the customer. Processing of the captured information may take place at a remote system, as discussed above.

In accordance with a second aspect, the present invention provides a system for facilitating account opening, the system comprising a processor, memory, and an operating system supporting computer processes, a communications interface arranged to receive customer data from an apparatus in accordance with the first aspect of the invention, and a verification process, arranged to carry out verification checks based on the customer data, and to provide verification back to the apparatus.

The verification checks may include any type of verification check. In an embodiment, they include an identity check. This may include checking a signature or biometric. The verification checks may also include an anti-money laundering (AML) check or any other checks. The system may be associated with a database containing data which can facilitate the verification checks. The system may also communicate with further systems to facilitate verification checks (e.g. a specialised system arranged to carry out AML, checks).

In an embodiment, the system comprises an account opening process which is arranged to open an account. The account may be opened by the system populating a database with details of the customer and any other requirements for account opening. In an embodiment, a separate account system may administer the account and store all account details.

In an embodiment, the system may communicate with a customer device, such as a customer computing device, to obtain confirmation from the customer before the account is opened. The customer device may be any computing device. It may be a mobile device, such as a smart phone, tablet or laptop. In an embodiment, the system has the advantage that it can communicate with the customer device in “real time”, in order to enable account opening quickly.

In accordance with a third aspect, the present invention provides a system for facilitating account opening, comprising a system in accordance with the second aspect of the invention and an apparatus in accordance with the first aspect of the invention.

In an embodiment, an apparatus and system in accordance with the present invention facilitate ease of opening of accounts. The accounts may be corporate accounts for trading on the primary market, stockbroking accounts for trading on the secondary market, or any other account. The account may be a betting account, or any other account.

In an embodiment, the account can be opened in “real time” at any convenient location. In embodiments, this is a significant advantage. For example, a stockbroker having lunch with a client may put a “deal” to the client. The client may not have an account. An account is easily opened, at the time (as long as the customer has sufficient identification available), so that the new account holder can purchase the stock.

In accordance with a fourth aspect, the present invention provides a computer program, comprising instructions for controlling a computing device to implement an apparatus in accordance with the first aspect of the invention.

In accordance with a fifth aspect, the present invention provides a computer readable medium, providing a computer program in accordance with the fourth aspect of the invention.

In accordance with a sixth aspect, the present invention provides a data signal, comprising a computer program in accordance with the fourth aspect of the invention.

In an embodiment, the computer program may be in the form of an “application” which may be downloaded to a mobile device of an administrator, in order to facilitate account opening.

In accordance with a seventh aspect, the present invention provides a computer program, comprising instructions for controlling a computer to implement a system in accordance with the second aspect of the invention.

In accordance with an eighth aspect, the present invention provides a computer readable medium, providing a computer program in accordance with the seventh aspect of the invention.

In accordance with a ninth aspect, the present invention provides a data signal comprising a computer program in accordance with the seventh aspect of the invention.

In accordance with a tenth aspect, the present invention provides a method of enabling account opening, comprising the steps of capturing, via a mobile device, customer data of a customer wishing to open an account, and authorizing, based on the customer data, opening of a customer account.

The mobile device may be a mobile computing device such as a smart phone, tablet or any other mobile computing device.

In an embodiment, the method comprises the further step of communicating the customer data to a remote system and carrying out verification steps at the remote system on the customer data. The verification steps may include steps for identifying the identity of the customer, anti-money laundering checks, and any other checks.

In an embodiment, the method comprises the step of capturing, via the mobile device, administrator data of an administrator administering opening of the account. In an embodiment, authorization of opening of a customer account depends on the administrator data.

### BRIEF DESCRIPTION OF THE DRAWINGS

Features and advantages of the present invention will become apparent from the following description of embodiments thereof, by way of example only, with reference to the accompanying drawings, in which;

FIG. 1 is a schematic diagram of an account opening apparatus and system in accordance with an embodiment of the present invention;

FIG. 2 is a schematic block diagram of an example computing system which may be utilised for implementation of an apparatus and system in accordance with an embodiment of the present invention;

FIG. 3 is a representation of application of an apparatus in accordance with an embodiment of the present invention;

FIG. 4 is a further representation of application of the apparatus of FIG. 3;

FIGS. 5a) and b) are respective representations of devices which may provide customer data;

FIGS. 6a), b) and c) are illustrations of displays of an apparatus operating in accordance with an embodiment of the present invention;

FIGS. 7a) and b) are further representations of displays of an apparatus operating in accordance with an embodiment of the present invention;

FIGS. 8 a), b), c) and d are further illustrations of displays of an apparatus operating in accordance with an embodiment of the present invention;

FIGS. 9 a), b) and c) are further representations of displays of an apparatus operating in accordance with an embodiment of the present invention;

FIGS. 10 a), b), c) are further representations of displays of an apparatus operation in accordance with an embodiment of the present invention;

FIGS. 11 a), b), c), d) are further representations of displays of an apparatus operating in accordance with an embodiment of the present invention;

FIG. 12 is an example of a message which may be provided in accordance with an embodiment of the present invention;

FIG. 13 is a representation of a further message which may be produced in accordance with an embodiment of the present invention;

FIG. 14 is a representation of a further message which may be produced by an apparatus in accordance with an embodiment of the present invention.

### DETAILED DESCRIPTION OF EMBODIMENT

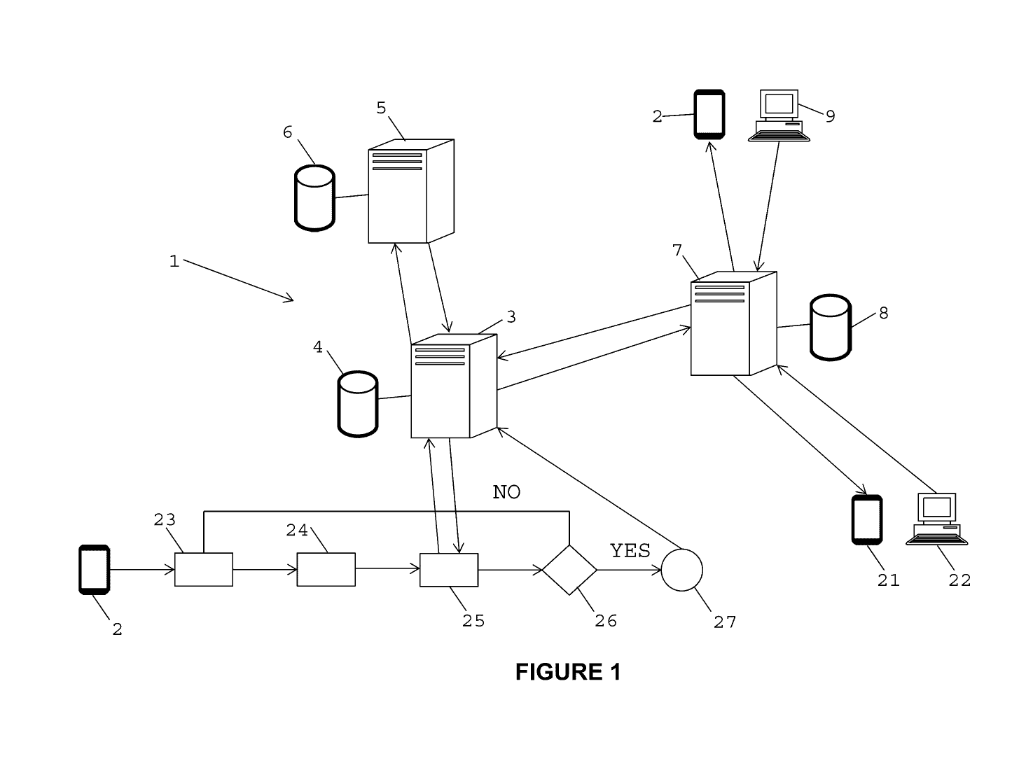

FIG. 1 schematically illustrates an apparatus and system in accordance with an embodiment of the present invention, generally designated by the reference numeral 1. An apparatus 2 for enabling account opening comprises a computing device, which in this example is a mobile device such as a smart phone, appropriately configured with computer processes to implement the embodiment.

The computer processes comprise an interface process, which is arranged to capture customer data of a customer wishing to open an account. They also comprise an authorisation process arranged to authorise, based on the customer data, opening of a customer account.

In this embodiment, mobile apparatus 2 comprises communications interface communicating with remote systems. In this embodiment, the remote systems comprise a server computer 3, which has a data base 4, as well as a processor and memory. The server computer 3 supports a verification process which facilitates verification steps utilising the data obtained by the interface process of apparatus 2. The verification steps may comprise any steps to satisfy any verification requirements. For example, the verification steps may require identification checks, signature matching, image matching, anti-money laundering (AML) steps, and more. In this example, once verification steps have been carried out, the server 3 may communicate with the apparatus 2 and the authorisation process may then authorise account opening.

As discussed above, the invention may be implemented by a computing device. This may be a smart phone, tablet, or any computing device which incorporates a processor and memory.

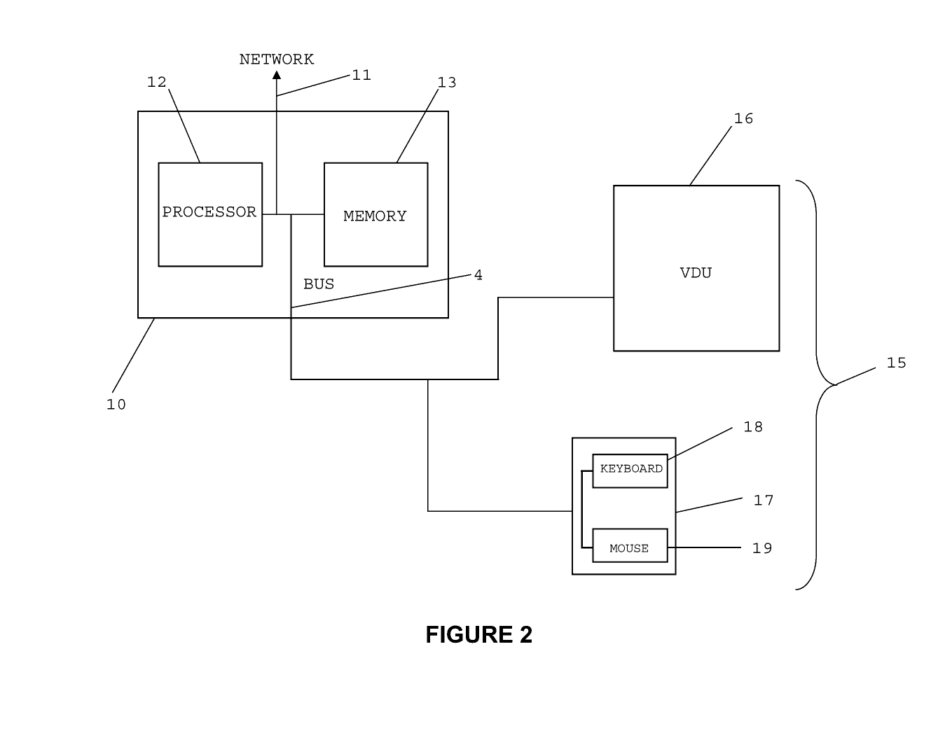

FIG. 2 is a schematic block diagram of an example computing system which may be utilised for implementation of a method and apparatus in accordance with an embodiment of the present invention. The apparatus, in this embodiment, may be a mobile device, such as a laptop, tablet or smart phone.

The illustrated computing system comprises a computer device 10 which includes a processor 12 and memory 13. The processor 12 is arranged to process programme instructions and data in a known manner. Memory 13 is arranged to store programme instructions and data also in a known manner. Processor 12 may constitute one or more processing means, such as integrated circuit processors. The memory 13 may comprise any known memory architecture and may include hard disk, IC memory (ROM, PROM, RAM, etc.), floppy disks and other types of additional memory such as CD ROM, and any other type of memory.

A BUS 4 is provided for communication between the processor 2 and memory 3 and also communication with external components. In this case the external components include a user interface 15. The user interface 15 includes a visual display unit 6 for displaying information to a user. The VDU 16 may display information in graphical format or any other format depending upon the programme instructions being processed by processor 12.

The user interface 15 also includes user input means 17 which in this example include a keyboard 18 and a mouse 19. The mouse 19 may be used to manipulate a graphical user interface (GUI) if a GUI is provided by software running on the computer. A network connection 11 is also provided for connecting to a network which may include a communication network and other computers/computing systems, such as server computer 3 (FIG. 1).

Although the computing apparatus of FIG. 1 may be implemented by any known type of computing hardware, in this embodiment, it is implemented as a smart phone. The mouse 19 may be dispensed with in this case and the VDU 16 may be a touch screen, implementing a keyboard 18 and other interface components.

The system 1, including the various server computing systems of FIG. 1, may be implemented by server/client architecture, “cloud” architecture, or any other computer architecture.

Computer processes run on the apparatus and system 1 may comprise software modules running on hardware, firmware, hardware implemented processors (e.g. field programmable gate arrays) or any other architecture.

An embodiment of an apparatus and system in accordance with the present invention will now be described in more detail.

Referring again to FIG. 1:

In addition to the server computer 3, database 4 and apparatus 2, the system also includes an AML verification server 5. This is associated with a database 6 to facilitate anti-money laundering checks. The server 5 and database 6 is administered by a secure organisation, such as Lab Group™.

An account administration server 7 is also established. The server 7 is arranged to open and administer customer accounts. In this embodiment, the server 7 may be administered by an organisation such as a brokerage, wishing to open accounts for trading on the primary market, and/or trading on the secondary market (stock market). The server 7 is arranged to communicate with computing devices, such as computers 9 and mobile devices 2 such as smart phones or tablets, which may be associated with administrators of the organisation. An administrator may be a broker, for example.

The server 7 may also communicate with customer devices 21, 22, which may comprise laptops, mobile devices such as smart phones, tablets or any other mobile devices.

The elements 23, 24, 25, 26, 27 in FIG. 1, denote various steps in an account opening and verification process, which will be described later.

Traditional ways of opening accounts, such as brokering or corporate accounts, didn't use to require too much security. Accounts could be opened during an ad hoc meeting (e.g. over lunch), and often were. This was advantageous to the capital industry. Accounts could be opened and stock bought, capital placed, without a great deal of bureaucratic procedure.

It is no longer possible to open accounts in such an informal manner. Many security checks are required. For example, for corporate accounts it is necessary to check that the customer opening the account is cleared of AML issues. Dedicated AML systems are arranged to run checks. Further, it is necessary to confirm identify of customers, using various checks (usually based on reliable identity devices, such as driving licenses, passports and other such devices). The server 3 may be able to undertake PCI-DSS checks. These checks implement the payment card industry data security standard. There are certain security requirements for credit card processes. This is a high level of identification.

A customer opening an account is usually required to attend at a specific location. For example, they may need to attend at the brokerage organisation with detailed account/identification information. AML checks must be run and other identification checks.

This makes the account opening process cumbersome and difficult. The advantages of opening the account process in “real time”, when a customer may wish to buy, are not available.

Similar issues arise when opening other types of accounts, such as bank accounts, gaming accounts (gambling) and other accounts.

The system of the embodiment of FIG. 1 enables real-time opening of accounts, in an embodiment, together with implementation of the necessary security checks. An account opening process utilising the system of FIG. 1 will now be described in more detail.

An administrator (e.g. a corporate broker) with an administrator device (e.g. smart phone 2) may be meeting with a client. They may be meeting in an ad hoc manner (e.g. over lunch, or at the office or any meeting). The potential customer is interested in taking a stake in a particular corporate deal e.g. an equity stake in a potential mine, or any other corporate deal. The administrator, with the device 2 appropriately supporting computer processes, is able to open a Customer Account in real time.

The administrator opens the “application” for account opening on the device 2. They are presented with an application landing page 23 (not shown). The application landing page may provide information relating to the system e.g. information advising customer that the system enables accounts to be opened. Please note that the terminology of Complii™, CPSCapital™ and Account Fast™, if used in this specification, are trade marks and not limiting to the scope and functionality of the invention.

The administrator may need to advise the account holder of terms and conditions and privacy. This may be done via the App or separately.

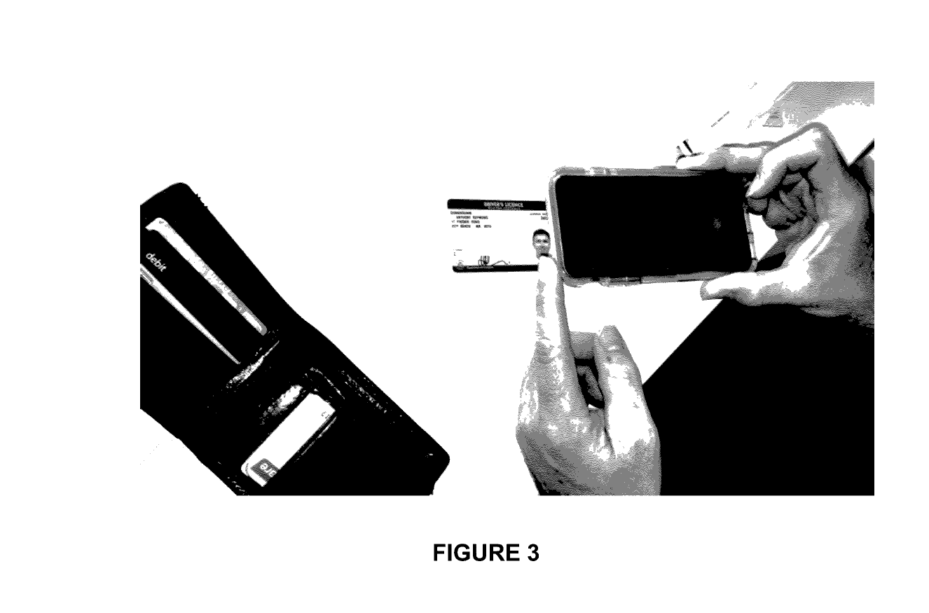

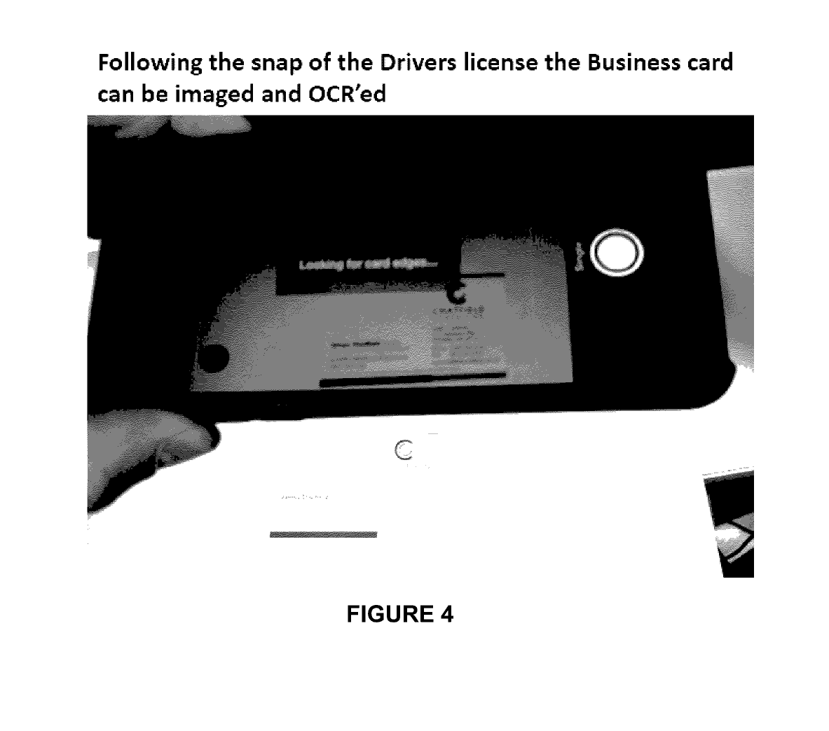

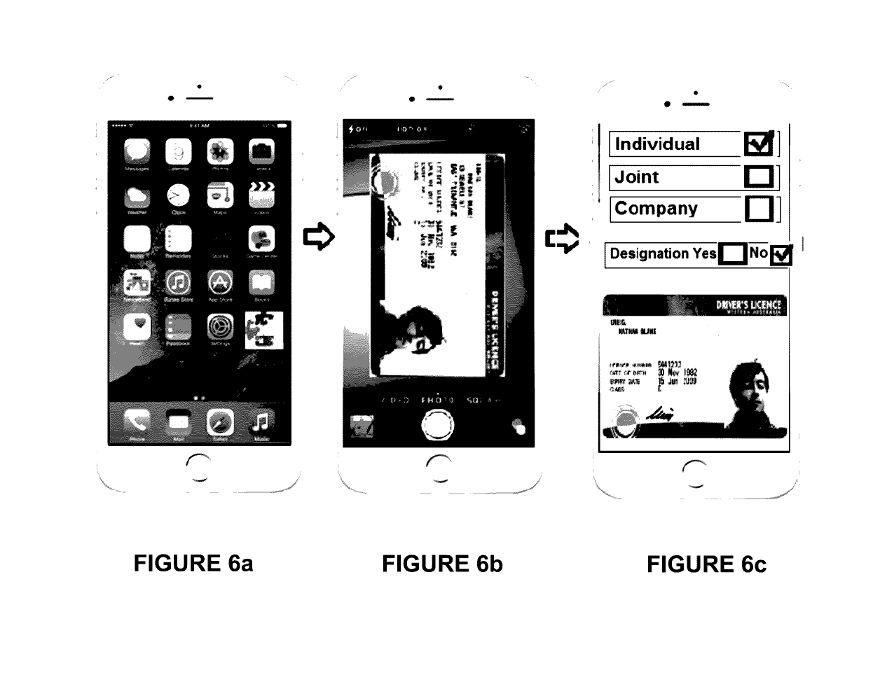

The administrator then uses the device 2 to collect customer data. In this embodiment, an optical character reader application 24 uses the device camera to take an image of an identification device, such as a driving license. See FIG. 3 and also FIGS. 6 a), b), c). Also FIG. 4. The optical character reader application 24 is configured to recognise relevant identification data within a captured image and extracts the relevant data for processing. For example, the optical character reader application can be configured to first identify the edges of the identification device in the captured image and from within this shape identify data components of the identification device (such as a photograph, signature image, typed text etc. on a driver's license, or name and address block and account details on a bank statement) based on characteristics of the component and location within the image. The optical character reader application 24 converts data (e.g. written script) captured from the device into text strings which can be communicated to remote systems 1. This text file/string is then pushed from the device 2 to server 3, step 25, for example the application generates a data communication signal (for example, M2M data message, formatted email etc.) encapsulating the text strings and other relevant data, such signature image and pictorial image, are encapsulated into a data communication signal and transmitted to the server 3 via a communication network. The server 3, is arranged to carry out identity checks etc. In response to receiving the data communication signal, the server creates a customer record in the database 4 and stores images and identification data. The server 3 then executes a verification process to verify the identity of the potential customer. For example, the server may be configured to communicate via a secure machine to machine (M2M) interface with third party servers to query the validity of the identification data, for example M2M communication to a government body server to query driver's license number and registered address details, or to a financial institution to verify account details. In such a communication the result of the query may be a simple positive or negative outcome, or additional information may be provided. For example, where a driver's license number and name are correct but a user's address details do not match those on the front of the driver's license then the verification reply may include a positive verification of the driver name but negative for address details and supply the registered address details. This scenario will be common where a user has changed address and the new address is typically recorded on a sticker on the back of the driver's license. In response to the address discrepancy the server may be configured to request further information via the application, or perform an alternative address verification with data already provided by the apparatus 2—for example comparing an entered current address with the address received from the driver's license verification server. If there remains a mismatch then the server may respond to the apparatus 2 with a verification check fail message, which may identify the failure cause being address details and allow a further attempt by the user to supply correct address details via the apparatus—the number of attempts may be limited (say to two). It should be appreciated that the actual registered address information remains secure as this is not transmitted back to the apparatus.

In this embodiment, the server 3 also communicates data to the server 5 to obtain AML verification. For example, via an M2M interface the server provides user identification data to the AML server. The AML server performs the verification check and outputs a result (i.e. pass or fail) to the server 3 via the M2M interface. A response is pushed from server 5 back to server 3.

It should be appreciated that the server 3 may be configured to interface with multiple third party servers to perform a plurality of different verification actions. The communications are performed via secure M2M interfaces between servers and the server configured to accumulate and assess the individual verification responses to determine an overall verification response. For example, a pass for all verification checks will provide a positive verification response. Some verification checks are mandatory to pass to allow an account to be opened, for example legal entity identification, tax file number (if supplied), AML, financial institution account checks may all be designated as mandatory and failure on any one or more cause the server to respond as verification failed and account refused. Some verification checks may result in a suspension of account setup, rather than denial, until the check can be passed, for example address verification. The server 3 generates and transits a data communication to the device 2 providing the verification response. The verification response message may include the verification outcome of each verification check performed.

At 25, the server 3 pushes the verification response back to the device 2. In response to receiving the verification response, the application on the device 2 then makes the decision as to whether or not the account can be opened for the customer. For example, if AML verification has not been achieved (step 26) a “NO” is established and the process comes to an end. No account is opened, because the customer has not been cleared.

The authorisation application on the device 2 therefore comprises logical processes for deciding whether an account should be opened or not. This may apply to a number of identification fields e.g. does the electronic signature match an electronic signature stored in a database:

is AML verification achieved;

is a credit check cleared, etc.

Decisions can then be made and they are to continue with the account opening process or discontinue the account opening process.

If “YES”, at step 27, account opening is pursued. The application may also determine if, based on the verification status, any limitations or conditions are applicable, for example if a tax file number is not supplied a condition to subject the account to withholding tax will be applied.

The application notifies the server 3 that an account can be opened. Identification data and data required to open the account is pushed from the server 3 to the organisation's server 7 where the account is to be administered.

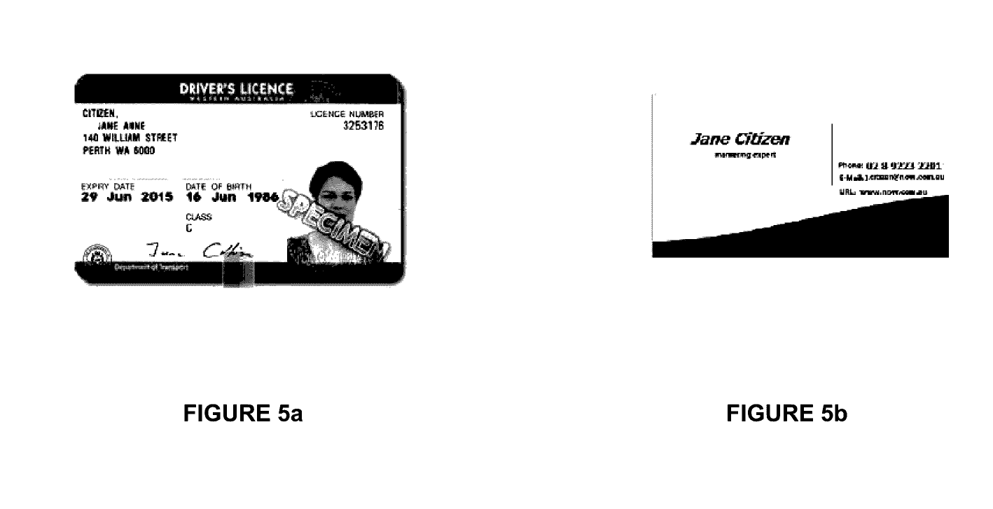

All the data necessary for opening an account can be captured by the device 2. In this embodiment, for example (ref FIG. 5), the driver's license can be scanned and also a business card can be scanned to obtain further information enabling opening of the account.

In this embodiment, an account for the customer is opened in database 8 with the customer details.

The application 24 may map all forms of identification, including passports, government ID, driver's licenses or other official, approved documentation. The application stores templates that map the identification device. The optical character recognition application extracts the information from the documents. If the OCR is not correct or mapped to the wrong field, the touch screen on the mobile device can be used to push the text from the wrong field to the correct field. For example, if the Name “John Citizen” was OCR'd to the Address field in error, the user can use their finger to drag the text (“John Citizen” from the Address field up to the Name field, dislodging the current Name field into the Address field. This can be done until all fields are correctly mapped.

It should be appreciated that embodiments of the system can be configured to utilisation with any form of identification document used for individual identification. For example, the system can be configured to recognise and verify individual identification data from passports, drivers licenses, credit cards etc. Some embodiments are further configured to perform verification in combination with biometrics (face, signature, eye, face, voice, finger). This may be referred to as mobile multi-factor digital verification (MMDV). In an embodiment, the device 2 application if configured to compare an image of the user captured from the photo on a driver's license with a live captured photograph of the user's face, say taken with the smartphone device or a camera connected to (or downloaded to) a computer. The application compares both captured images and performs a biometrics facial scan and validate that the face spatial points map to the same face spatial points on the driver's license photo. In another embodiment biometric information, such as fingerprints, iris or retina scan, voice, signature etc. are captured from the user the device 2 and communicated to the server 3 for verification via communication with a third party system similarly to the verification process described above. For example, the server 3 may be configured to search a fingerprint data base via a secure M2M interface.

Any errors that occur at entry of the information with apparatus 2, can be corrected at the “back end” system 1. For example, an administrator of system 7, administering the account, may correct details that are in error.

In this embodiment, the application 24 may include a process which automatically adds the customer details to the “Contacts” of the administrator apparatus 2.

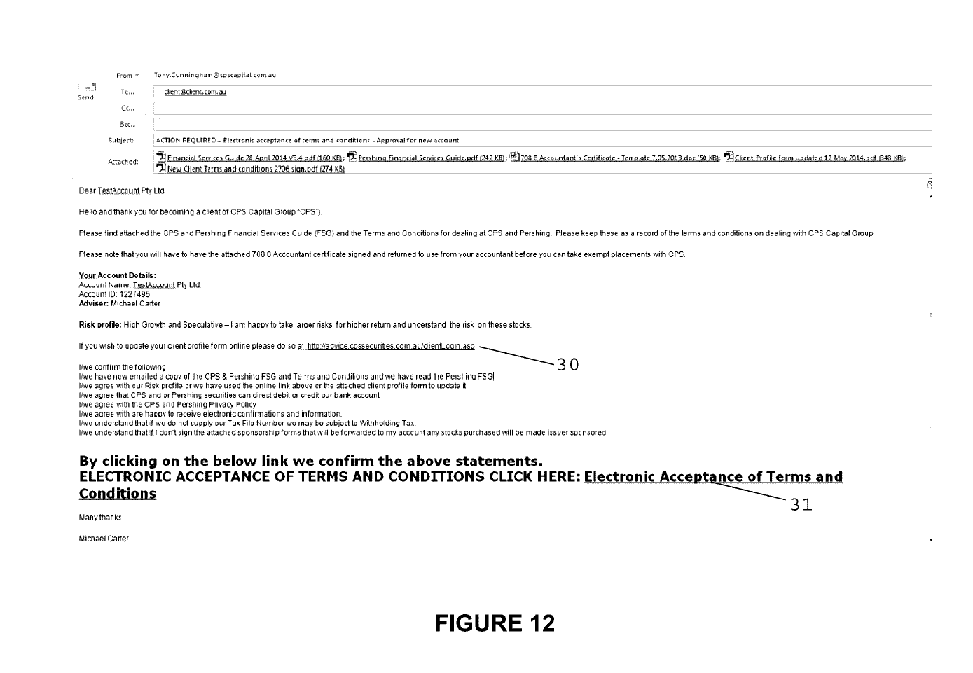

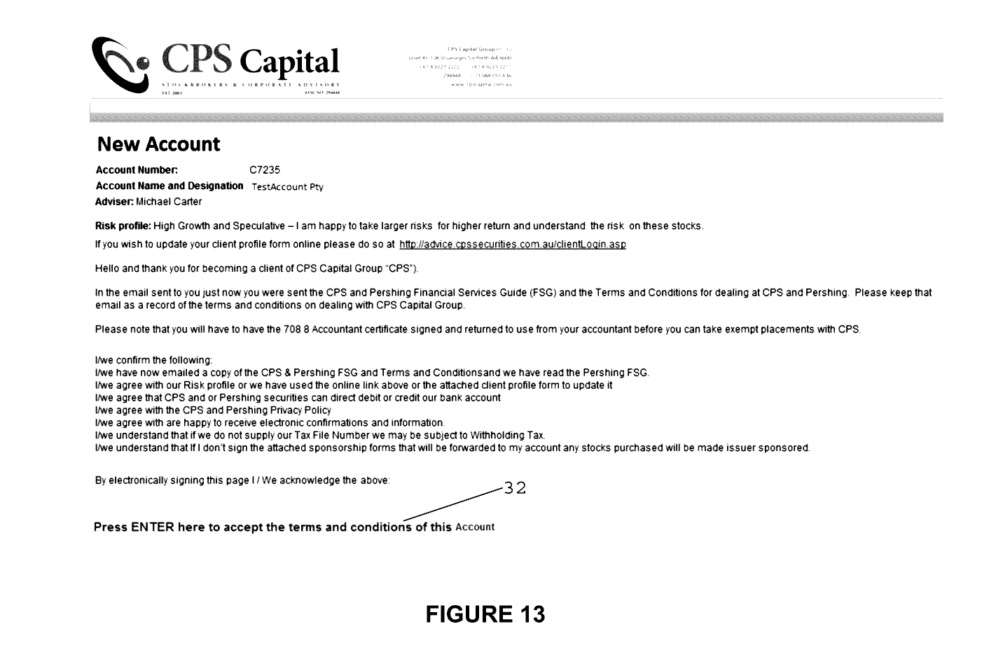

In a further security option, and also to enable an account to be opened where a sign off is required by the customer (such as a corporate account), the server 7 may communicate with the customer's device 21. A message such as an e-mail may be sent to the customer device 21. See FIGS. 12 and 13. A link back to the system 7 (reference numeral 30) may enable updating of a client profile form, with various information necessary to open an account. Further, a link 31 enables electronic acceptance of terms and conditions. Clicking on this means that the customer accepts all terms and conditions and the account is opened. This may also trigger generation of a digital signature to append to the acceptance. All this can be done in real time.

FIG. 13 is another example of an e-mail that may be sent to a customer. Link 32 enables opening of the account, by linking back to the server and enabling acceptance of the terms and conditions.

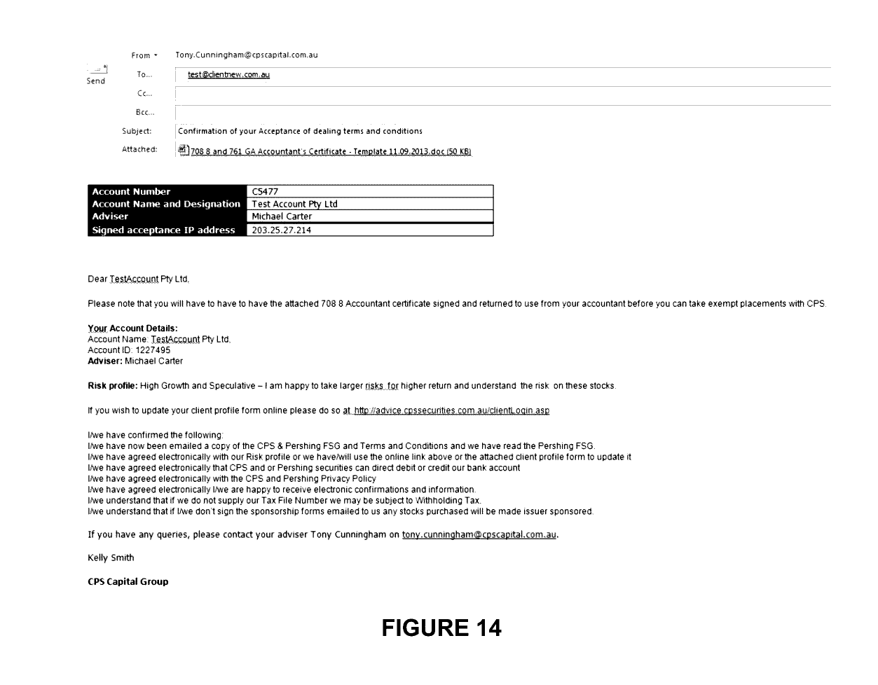

Various other requirements (particular to corporate financial accounts) may be required to be satisfied. Requirement may be for a customer to be a “sophisticated investor” (708 status). Other communications (see FIG. 14, for example) may be sent to the customer. FIG. 14 shows a message that enables confirmation of 708 status by the customer.

The apparatus and system of this embodiment may be utilised with the apparatus of the system of Applicant's earlier Patent Application No. 2014274538, which relates to management of corporate accounts and on-line trading. The entire contents of that application are considered incorporated herein by reference.

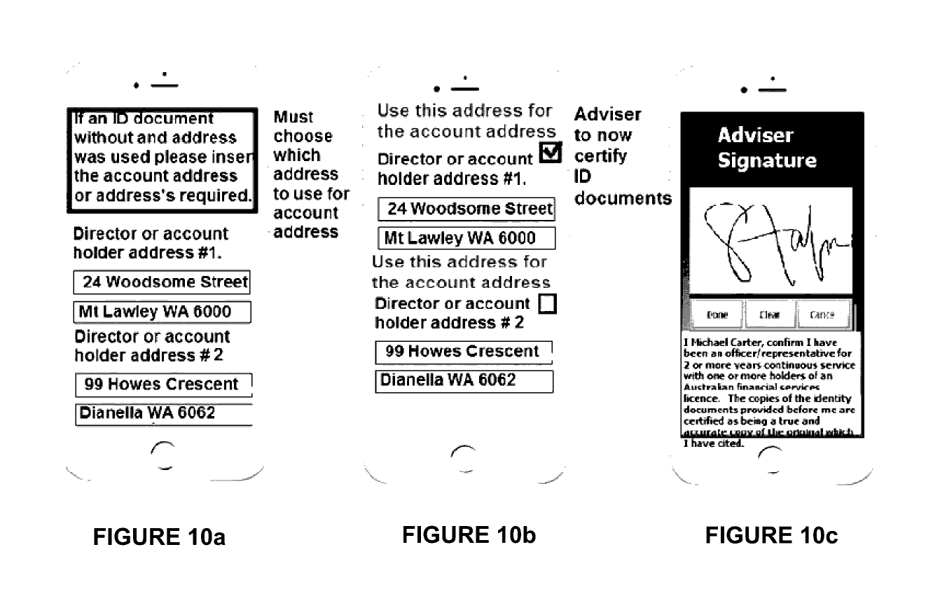

One of the further verification features of this embodiment of the invention is the requirement for an administrator to provide identity information via the apparatus 2 to the system 1. Referring to FIG. 10 c), the broker/advisor (operator of device 2) is asked to provide his signature via the application. This signature is checked by the server 3 and database 4 before account opening can be confirmed. This provides a further safeguard that the account information is correct and for a valid customer.

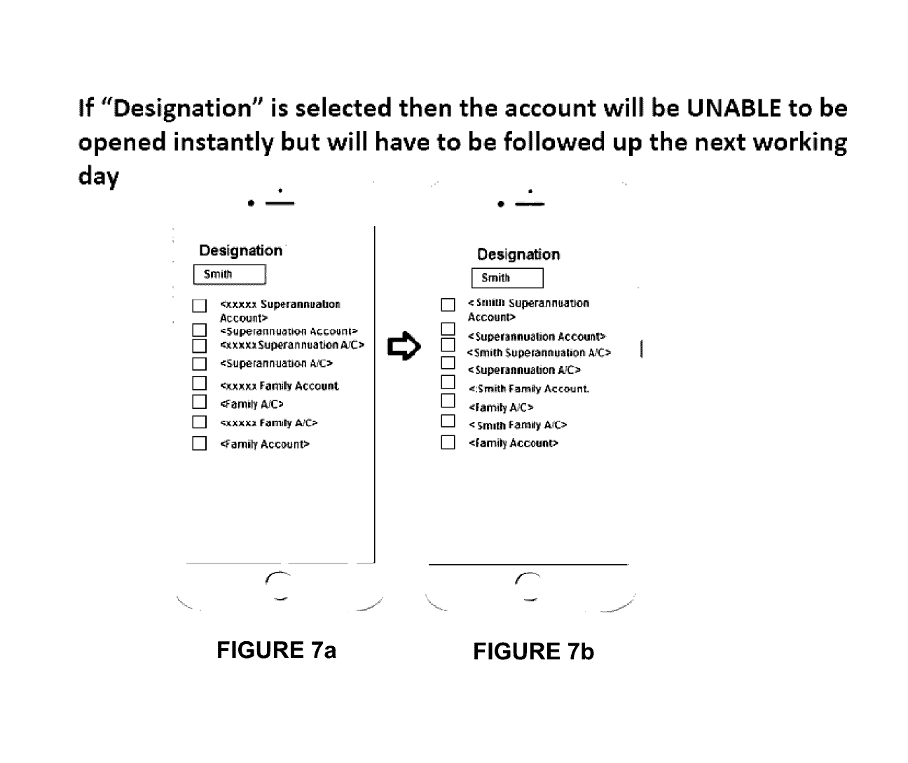

FIGS. 6 through 11 show various options for taking information to enable the account to be opened. FIGS. 6 b) and c) show obtaining of identification data (driver's license). Options are given to enable the customer to designate “individual”, “joint” and “company” as the account holder. If “designation” is checked, the account will be unable to be opened instantly, but will have to be followed up the next working day. This provides some “cooling off” facility. In this case (FIG. 6 c)), it can be seen that Designation has not been selected.

Screen 7 a) and b) show various account details that can be checked i.e. account type.

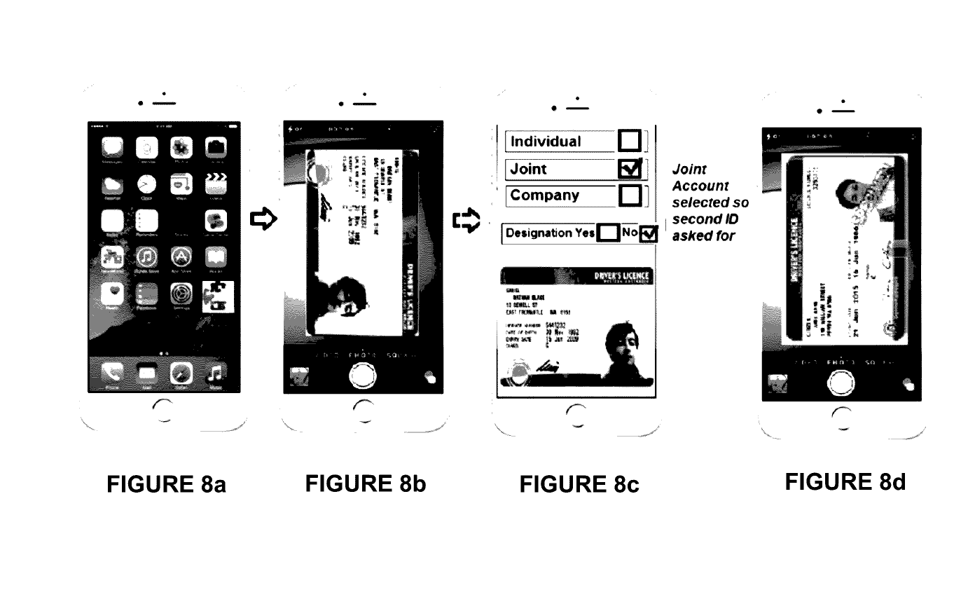

FIG. 8 c) shows the option for “joint” account. A second ID is then asked for (FIG. 8 d)).

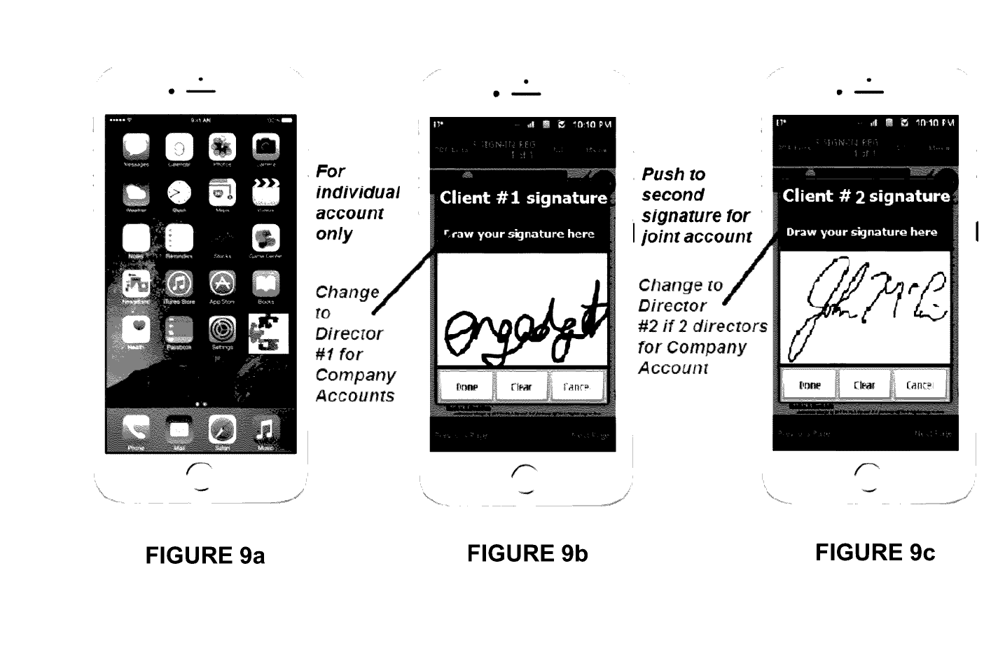

FIGS. 9 b) and c) show obtaining signatures of customers.

FIGS. 10 a) and b) show details being entered into the application.

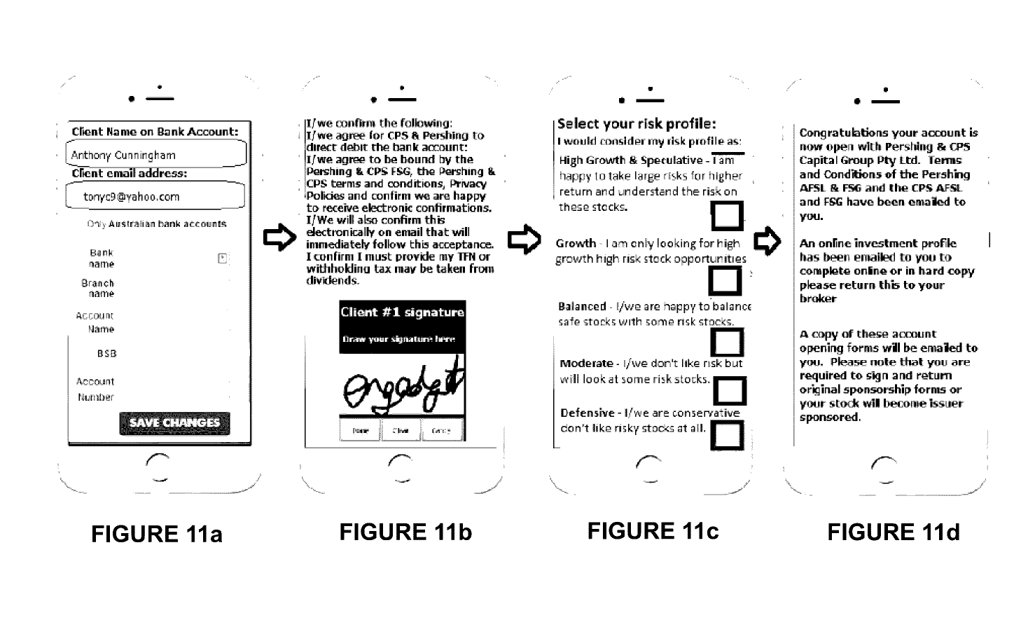

FIGS. 11 a), b), c), d) illustrate various options. FIG. 11 b) is agreement with terms and conditions. FIG. 11 c) allows a customer to choose their risk profile for investment. Figure d) is confirmation of account opening. This may require e-mails generated and accepted in accordance with FIGS. 12, 13 and 14 before the account is opened.

Type of data required for account opening may be any data that will enable the account to be opened. It may, for example, include:

For an individual:

1) date of birth;

2) name;

3) expiry date of driving license;

4) image of the license;

5) driving license number;

6) type of document;

7) signature attached to ID

(and from a business card):

7) phone number;

8) e-mail address;

9) employer

10) occupation.

Different details will obviously be required for a company.

In the above embodiments, and electronic signature and visual representation of the customer are used for identification purposes. Electronic signature is also used for verification of an administrator facilitating the account opening. The invention is not limited to these identification forms. Other technologies for identification may be utilised in the alternative or additionally to these forms. For example, in other embodiments, technologies such as voice recognition, photo biometrics, retina scans, eye scans, fingerprint scans or any other technology.

The present invention is not limited to the opening of corporate accounts for investment. Any type of account may be opened. This could include accounts trading on the stock market, gaming accounts (gambling), bank accounts, or any other account.

In the above embodiment, separate server systems are used for AML, check, identify check and account administration. The invention is not limited to this architecture. A single server or system may be used to carry out all three processes, or more than three servers may be utilised. Any architecture is available.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

What is claimed is:

1. An apparatus for enabling account opening, comprising a computing device having a processor, memory and an operating system supporting computer processes, a data interface process arranged to capture customer data of a customer wishing to open an account, an authorisation process arranged to authorise, based on the customer data, opening of a customer account.

2. An apparatus in accordance with claim 1, wherein the apparatus is a mobile device.

3. An apparatus in accordance with claim 1, further comprising a communications interface for communicating with remote systems, the authorisation process being arranged to communicate the customer data to a remote system where verification steps are carried out utilising the data.

4. An apparatus in accordance with claim 3, wherein the authorisation process is arranged to receive, from the remote system, authorisation for account opening.

5. An apparatus in accordance with claim 1, wherein the data interface process is arranged to capture administrator data of an administrator.

6. An apparatus in accordance with claim 5, wherein the authorisation process is arranged to require the administrator data in order to authorise account opening.

7. An apparatus in accordance with either claim 5, wherein the authorisation process is arranged to send the administrator data to a remote system where verification steps are carried out on the administrator data.

8. An apparatus in accordance with claim 1, wherein the data interface process is arranged to capture an image which may contain customer data.

9. An apparatus in accordance with claim 1, wherein the authorisation process is arranged to receive information from remote systems on verification steps carried out utilising the customer data, and make decisions on whether or not to proceed.

10. A system for facilitating account opening, the system comprising a processor, memory, and an operating system supporting computer processes, a communications interface arranged to receive customer data from an apparatus in accordance with claim 1, and a verification process, arranged to carry out verification checks based on the customer data, and to provide verification back to the apparatus.

11. A system in accordance with claim 10, further comprising an account opening process which is arranged to open an account.

12. A system in accordance with claim 11, wherein the system is arranged to communicate with a customer device, such as a customer computing device, to obtain confirmation from the customer before the account is opened.

13. A system for facilitating account opening, comprising
a system in accordance with claim 10; and
an apparatus for enabling account opening, comprising a computing device having a processor, memory and an operating system supporting computer processes, a data interface process arranged to capture customer data of a customer wishing to open an account, an authorisation process arranged to authorise, based on the customer data, opening of a customer account.

14. A computer program, comprising instructions for controlling a computing device to implement an apparatus in accordance with claim 1.

15. A computer readable medium, providing a computer program in accordance with claim 14.

16. A data signal, comprising a computer program in accordance with claim 14.

17. A computer program, comprising instructions for controlling a computer to implement a system in accordance with claim 10.

18. A computer readable medium, providing a computer program in accordance with claim 17.

19. A data signal, comprising a computer program in accordance with claim 17.

20. A method of enabling account opening, comprising the steps of capturing, via a mobile device, customer data of a customer wishing to open an account, and authorizing, based on the customer data, opening of a customer account.
